(19) United States
(12) Patent Application Publication
(10) Pub. No.: US 2015/0212009 A1
(43) Pub. Date: Jul. 30, 2015

(54) METHOD AND DEVICE FOR IDENTIFYING MATERIALS IN A SCENE

(71) Applicant: VIT, Saint Egreve (FR)

(72) Inventor: Romain Roux, Saint Andre Le Gaz (FR)

(21) Appl. No.: 14/418,172

(22) PCT Filed: Aug. 2, 2013
(86) PCT No.: PCT/FR2013/051875

§ 371 Date: Jan. 29, 2015

(30) Foreign Application Priority Data
Aug. 2, 2012 (FR) 12/57518

(51) Int. Cl. G01N 21/88; G01N 21/95; G01N 21/21

(52) U.S. Cl. CPC G01N 21/8851; G01N 21/21; G01N 21/9501; G01N 2021/1765

(57) ABSTRACT

The invention relates to a method for identifying a material in a scene, including the following steps: lighting the scene (1); taking at least two simultaneous measurements of the light amplitude of the scene for separate polarisation states of the light using two measurement devices positioned in inclined directions above the normal of the scene; and deducing an identification of the material therefrom.

### BACKGROUND

The present invention relates to a device and a method for identifying materials in a scene. More particularly, the present invention relates to such devices and methods capable of rapidly identifying materials in a scene, for example, on an assembly line.

### DISCUSSION OF THE RELATED ART

On assembly of printed circuits, many alignment and positioning tests are performed at different stages of the assembly. Particularly, a first alignment and positioning test is currently performed after the forming of solder pads on a printed circuit board. This first test enables to determine whether the pads are properly distributed at the board surface.

Components or chips are then positioned on the printed circuit board so that their terminals coincide with solder pads. A second alignment and positioning test may be performed after this component positioning step. A last step comprises annealing the structure to melt the solder pads so that the components or chips are held in position on the integrated circuit board.

In a conventional assembly method, the integrated circuit boards are placed on a conveyor and the assembly steps are performed sequentially. Many devices for testing boards positioned on conveyors are known, particularly devices integrating optical inspection elements.

It would be however advantageous to also identify the materials present in the scene. Identification of a material here indifferently means determining a group of materials comprising the material to be identified, that is, for example the nature of the material (dielectric, conductor . . . ), determining the actual material (copper, aluminum . . . ), or making a distinction between different surface conditions of a same material (a plurality of roughness or oxidation levels, for example).

It has already been provided to identify materials by performing color detections in a two-dimensional scene. A disadvantage is that the result is relatively dependent on lighting conditions. Further, such a method is limited as to the number of materials which can be detected. It is further poorly adapted to an identification of materials in a three-dimensional scene, shadows of raised elements being capable of distorting the identification.

There thus is a need for a relatively fast method and device for identifying materials in a scene, that is, capable of performing identifications on mobile scenes, and particularly on an assembly line.

### SUMMARY

An object of an embodiment is to provide a device and a method for identifying materials in a scene.

Another object of an embodiment is to provide a particularly fast solution adapted to mobile scenes, particularly on an assembly line.

Another object of an embodiment is to provide a device and a method capable of identifying materials in a three-dimensional scene.

To achieve all or part of these and other objects, the present invention provides a method of identifying a material in a scene, comprising the steps of: lighting the scene; taking at least two simultaneous measurements of the light amplitude of the scene for different states of light polarization by means of at least two measurement devices positioned along directions inclined above the normal of the scene; and deducing an identification of the material therefrom.

An embodiment of the present invention further provides a system for identifying a material in a scene, comprising at least one element of a first type selected from among a light source and an image acquisition device and at least two elements of a second type, different from the first type, selected from among an image acquisition device and a light source, each second element being associated with a rectilinear polarizer in a fixed relationship.

According to an embodiment of the present invention, the optical axis of each element of the second type forms, with respect to the optical axis of the element of the first type, an angle in the range from 5 to 50°, the elements of the second type being regularly distributed around the optical axis of the element of the first type.

According to an embodiment of the present invention, the image acquisition device(s) acquire images of the light amplitude of the scene for different light polarization states.

According to an embodiment of the present invention, the system further comprises a processing device capable of identifying, based on the images acquired by the image acquisition device(s), a material in the scene.

According to an embodiment of the present invention, the system further comprises a device for determining the topology of the scene, the processing device receiving information from the determination device.

According to an embodiment of the present invention, the element of the first type is placed along an axis normal to the plane of the scene.

According to an embodiment of the present invention, the elements of the second type are light sources.

An embodiment of the present invention further provides a method such as described hereabove, implementing the system such as described hereabove, wherein the light sources are alternately activated, the image acquisition device being provided to acquire an image for each source activation alternation.

An embodiment of the present invention further provides an installation comprising a part conveyor and a system for identifying a material in the parts such as described hereabove.

### BRIEF DESCRIPTION OF THE DRAWINGS

The foregoing and other features and advantages will be discussed in detail in the following non-limiting description of specific embodiments in connection with the accompanying drawings, among which:

FIG. 1 illustrates a printed circuit board inspection device;

FIG. 2 illustrates a known device for identifying materials present in a two-dimensional scene (2D);

FIG. 3 is a curve illustrating the principle of a device according to an embodiment;

FIG. 4 is a block diagram of a system according to an embodiment;

FIG. 5 is a perspective view illustrating notations used to describe embodiments;

FIG. 6 illustrates an embodiment of an element of the system according to an embodiment;

FIG. 7 illustrates another embodiment of an element of the system according to an alternative embodiment;

FIG. 8 illustrates another embodiment of an element of the system according to an alternative embodiment; and

FIGS. 9 and 10 show, in the form of block diagrams, embodiments of a method for identifying a material in a scene.

For clarity, the same elements have been designated with the same reference numerals in the different drawings and, further, as usual in the representation of test systems, the various drawings are not to scale.

### DETAILED DESCRIPTION

FIG. 1 schematically shows an example of such an installation, such as described in documents EP-A-2413132 and US-A-2012/019651. Electronic circuits IC, for example supported by a printed circuit board ICC, are placed, for example, on a conveyor 1 of an in-line optical inspection installation. The installation comprises a system 2 of digital cameras, connected to an image processing computer system 3. Conveyor 1 is capable of moving in a plane X, Y (generally horizontal) and, for a series of photographs, in one of the two directions only, that is, direction X.

Digital camera system 2 may take a plurality of forms. It has in particular been provided to detect the positioning of chips or of components on a printed circuit board by a detection of shapes at the board surface, that is, by a detection of the three-dimensional structure of the device. If a component, a chip, or a solder pad is not properly positioned, this can be detected by comparing the board topology with a reference topology.

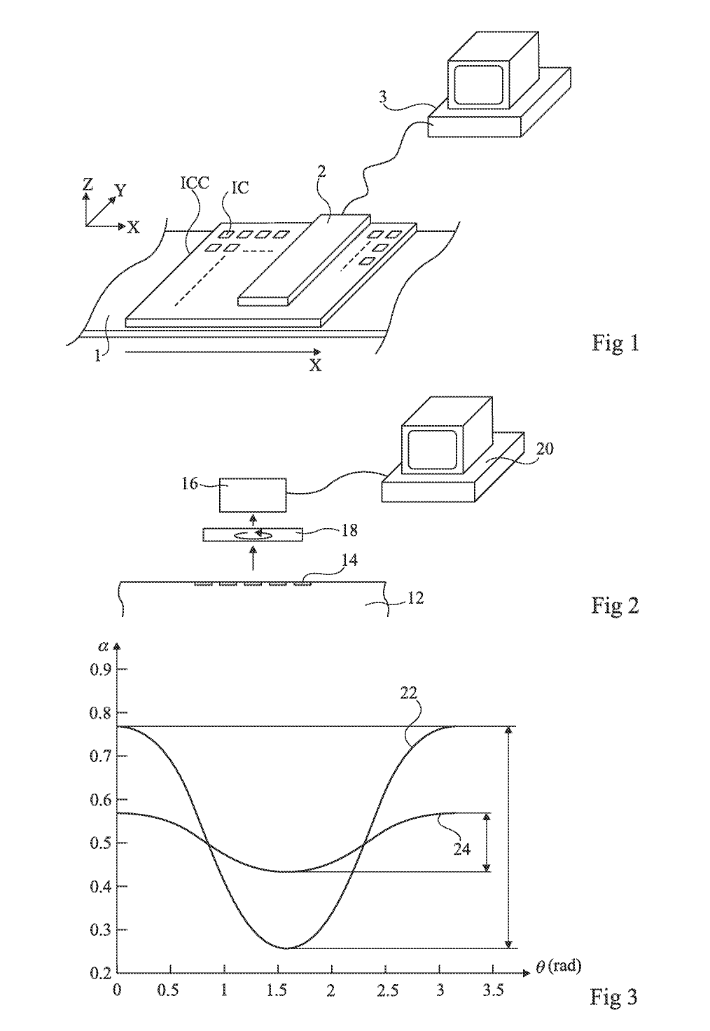

FIG. 2 illustrates a known device for identifying materials present in a two-dimensional scene (2D).

The device comprises a wafer 12 having patterns 14 made of a material from that of the wafer, and which is desired to be identified, formed at its surface. Wafer 12 is for example illuminated by ambient light. A camera 16 is placed opposite wafer 12 and is positioned to acquire an image of at least a portion of the surface of wafer 12, the structure of which is desired to be identified by the identification of the material. In the shown example, the optical axis of the camera is orthogonal to the wafer surface. It should be noted that an oblique positioning of the camera is also possible.

A rotating linear polarizer 18 is placed in front of camera 16. Polarizer 18 may for example be formed of a bi-refringent lens which amplifies the light intensity along a light polarization axis and attenuates the light intensity along another light polarization axis, orthogonal to the first axis. The camera is associated with processing and calculation means 20.

The rotating linear polarizer is used as an ellipso-meter. This enables to map the light intensity according to the direction of the polarization. To perform this mapping, the rotating linear polarizer may for example be assembled on a motor-driven shaft.

It should be noted that a similar detection may be performed by means of a device comprising an association of two linear polarizers positioned around a voltage-controlled liquid crystal time delay unit.

FIG. 3 illustrates a result capable of being obtained by the device of FIG. 2. More particularly, FIG. 3 illustrates two ellipsometric curves determined by means of the device of FIG. 2, originating from measurements performed for two pixels of the camera directed towards points of the scene made of different materials. These curves illustrate the modulation coefficient of the incident intensity according to the rotating polarizer angle (in radian) for a first pixel of the camera which is directed towards a first material at the surface of support 12 (curve 22) and for a second pixel of the camera which is directed towards a second material at the surface of support 12 (curve 24).

As can be seen in FIG. 3, curves 22 and 24 have different amplitudes over the possible polarization angles. In the shown example, curve 22 corresponds to the acquisition performed by a pixel of camera 16 which detects an area of a conductive material, and more particularly of copper. Curve 24 corresponds to the acquisition performed by a pixel of camera 16 which detects an area of a dielectric material.

Measurements such as that of FIG. 2 can thus be used to obtain information relative to the material having reflected the light wave. Indeed, each material has an ellipsometric signature linked to its composition, and particularly to its refraction index. A comparison between an ellipsometric signature and reference signatures enables to determine the associated material.

However, an identification of materials by ellipsometry cannot be implemented in the case of the processing of a mobile scene, for example, on an assembly line, where the time allowed for each acquisition is decreased. Indeed, to perform an identification by ellipsometry and thus by comparison of ellipsometric curves, the measurement of many points for different positions of the rotating linear polarizer is necessary, such a measurement being time-consuming. An identification of materials by ellipsometry can further not be implemented in the case of a processing of a deformable scene having an unknown topology. The use of a structure comprising two polarizers coupled to a liquid crystal time delay unit also implies a measurement time prohibitive for an application on an assembly line.

According to an embodiment, the system for identifying materials in a scene comprises no variable polarization device. A variable polarization device is a device capable of polarizing a light beam which crosses it with a polarization which varies along time. It for example is a rotating linear polarizer such as previously described. According to an embodiment, each polarizer used in the identification system is in a fixed relationship with the image acquisition device or the light source associated therewith. The identification system comprises no optical beam splitter either.

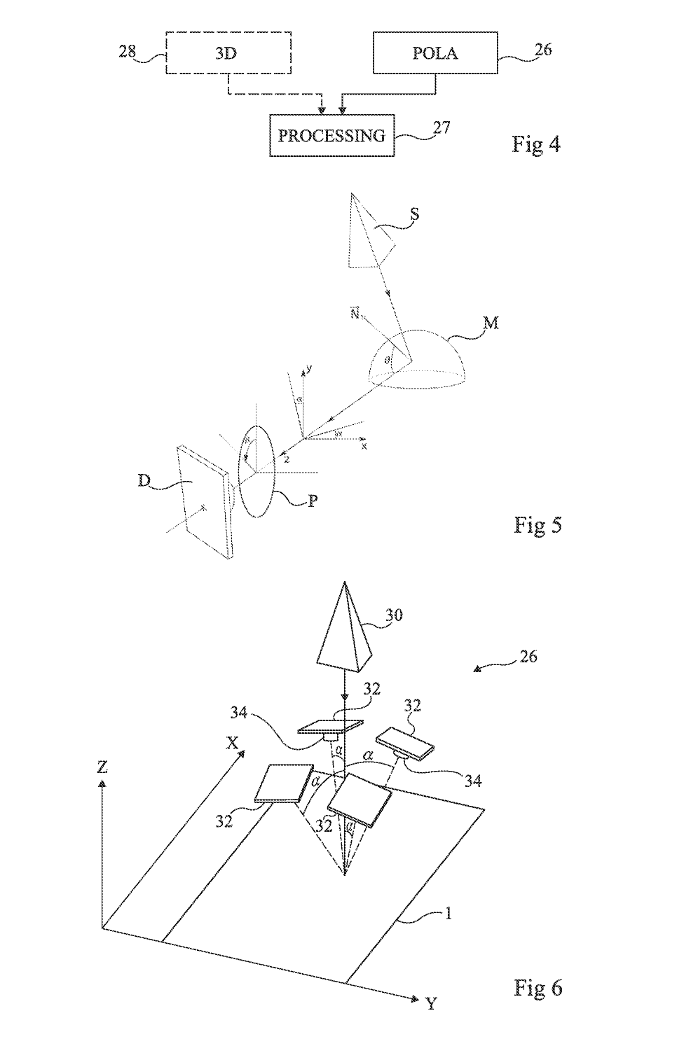

FIG. 4 is a block diagram illustrating a system according to an embodiment enabling to identify materials in a scene, compatible with an identification on an assembly line.

A measurement device 26 (POLA) detects, for each elementary area of the scene, the light amplitude reflected by this area for at least two different light polarization states. The system comprises a processing and calculation device 27 (PROCESSING) which, based on the data delivered by system 26, provides an identification of the material present in the elementary area of the scene.

The system further comprises a device for determining the topology of scene 28 (3D). In the following description, scene topology designates a description of the relief of the scene. The determination of the scene topology may comprise determining a three-dimensional image of the scene. A three-dimensional image corresponds to a cloud of points, for example, comprising several million points, of at least a portion of the external surface of the scene, where each point of the surface is located by its coordinates determined with respect to a three-dimensional space reference system.

In the case of a three-dimensional scene, due to the presence of the device for determining the topology of scene 28, the value of the vector normal to the surface of the scene \vec{N} is known at any point in the scene. To determine the scene topology, various devices may be used. Systems such as those described in patent application US 2012/019651 of the applicant may in particular be used. This device comprises, in a plane orthogonal to the forward direction of a conveyor, a set of two projectors, each projector being associated with a plurality of cameras to obtain a 3D image capture system. Calculation and processing means apply a super-resolution process to the obtained data.

Of course, other devices for determining the topology of the 3D scene may also be used as device 26.

Device 26 for determining the scene topology may correspond to a device different from measurement device 26. As a variation, at least certain elements of the device for determining the topology of scene 28, particularly cameras and/or projectors, may be common with measurement device 26.

In another embodiment, the scene topology and the position of the scene relative to the acquisition devices may originate from a digital description file and correspond to a theoretical topological representation of the scene.

The reflection of a light wave on a surface implies a variation of the polarization of the wave having its amplitude depending, apart from refraction index η of the detected material, on the geometry of the analyzed surface, on roughness r of the surface, and on wavelength λ of the light beam illuminating the surface. Roughness r of the surface and wavelength λ of the light beam illuminating the surface will be neglected or assumed to be constant in the present case.

The geometry of the analyzed surface may be characterized by a vector \vec{N} normal to the analyzed surface. Thus, the polarization state of a light wave reflected on a surface depends on the polarization state of the initial wave projected on the surface, on parameters \vec{N}, r, and λ, and on refraction index η of the material.

Amplitude I(η, θ′, α, β) of the light diffused by a material located in a three-dimensional scene and measured by a sensor positioned behind a rotating linear polarizer may be written according to the following relation (1):

$$I ( η , {θ}^{′} , α , β ) = \frac{{I}_{d}}{2} [ \frac{{( a - cos ( {θ}^{′} ) )}^{2} + {b}^{2}}{\begin{matrix}( {a}^{2} + {b}^{2} ) {tan ( {θ}^{′} )}^{2} + 2 a \cdot cos ( {θ}^{′} ) {tan ( {θ}^{′} )}^{2} + \\ 2 ( {a}^{2} + {b}^{2} ) + {sin ( {θ}^{′} )}^{2} {tan ( {θ}^{′} )}^{2}\end{matrix}} cos ( 2 ( α - β ) ) + 1 ] \\ with \text{:} \\ 2 {a}^{2} = \sqrt{{n}^{2} - {k}^{2} - {sin ( {θ}^{′} )}^{2} + 4 {n}^{2} {k}^{2}} + {n}^{2} - {k}^{2} - {sin ( {θ}^{′} )}^{2} \\ 2 {b}^{2} = \sqrt{{n}^{2} - {k}^{2} - {sin ( {θ}^{′} )}^{2} + 4 {n}^{2} {k}^{2}} - {n}^{2} - {k}^{2} - {sin ( {θ}^{′} )}^{2} \qquad ( 1 )$$

n and k respectively being the real part and the imaginary part (absorption index) of refraction index η of the material, a pair (θ, α) representing the first two spherical coordinates (zenith and azimuth) of normal \vec{N} to the surface observed in the camera reference system, angle θ′ being the angle of the radius refracted in the material, obtained from angle θ by applying the Snell-Descartes law (sin(θ)=n·sin(θ′)), and β being the polarizer angle.

FIG. 5 schematically illustrates the different angles mentioned in the above formula. This drawing shows a light source S which illuminates the surface of a material M. The beam reflected by an elementary portion of surface M towards a detector or a camera D is here considered, a polarizer P being placed on the path of the wave reflected by the material.

Reference system (x, y, z) of the camera is defined so that axis z coincides with the direction of the beam reflected by material M. Angle β of polarizer P is defined in the present example as being the angle formed, in a plane normal to direction z, with axis y. Angle θ is the angle formed between direction z and the direction of normal \vec{N} to the surface of material M, and angle α is the angle formed between a projection of normal \vec{N} in a plane (x, y) and axis y of this plane.

It should be noted that the diffuse component of the beam is here considered, which is, in the Fresnel model, a component transmitted by the inner layer of the material. I(1/η, θ′, α, β) should thus be used to express the intensity measured by the sensor.

It is here provided to perform, by means of measurement device 26, a plurality of acquisitions of the amplitude of the light reflected by the different materials in the scene, for different polarization states of this light. Be the scene two-dimensional (normal vector \vec{N} orthogonal to the scene surface) or three-dimensional, the device provided herein has the same operation.

Measurement system 26 is provided to obtain at least two pieces of information relative to the modification of the light beam by the reflection on the pixel, and this for at least two polarization states, as will be seen hereafter.

In particular, if it is desired to determine the nature of the materials present in the scene, for example, dielectric or conductive, a small quantity of information relative to the amplitude of the light beam by reflection on the pixel is necessary. Indeed by properly specifying the polarization states which are detected, the amplitude variation on the material can be determined, such a variation being directly linked to the nature of the material. If more accurate information relative the material is desired, for example, if the refraction index thereof is desired to be determined, four acquisitions of different polarization states may be necessary.

FIG. 6 illustrates in further detail an embodiment of a measurement system 26 of FIG. 4.

Measurement system 26 comprises a projector 30 having its optical axis extending along a direction normal to the direction of the scene to be analyzed.

In the shown example, system 26 further comprises a set of four cameras 32 (four acquisitions in parallel) placed to acquire, from different viewpoints, an image of the scene centered on a same point. The point at the center of the images acquired by cameras 32 may be confounded with the center of the beam provided by projector 30. As an example, cameras 32 may be inclined according to a same angle α with respect to the optical axis of the projector and be regularly positioned around the optical axis of projector 30. Angle α formed between the optical axis of cameras 32 and the optical axis of cameras 30 may be in the range from 5 to 50°. It should be noted that a significant angle improves the quality of the identification. It should also be noted that more or less than four cameras may be provided, as described hereabove. According to a variation, angle α may be different for each camera.

A rectilinear polarizer 34 fixed with respect to each of the cameras is placed in front of each of cameras 32. Processing and calculation device 27 (not shown in FIG. 6) receives the acquisitions of the different cameras and identifies, for each pixel of the scene, by means of the knowledge of the pixel topology, the material present at the level of the pixel of the scene.

A plurality of configurations of the rectilinear polarizers in front of each of the cameras is possible, what matters being for the cameras to have different points of view on the scene. Indeed, this causes variations of the intensities measured by the different cameras. Rectilinear polarizers 34 may be placed in front of each of the cameras to have a same polarimetry configuration, that is, the polarization angles of the polarizers are rotationally symmetrical around the optical axis of projector 30. If the variation of the intensities measured by the different cameras is desired to be increased, the angles of the polarizers may also be shifted between cameras. Indeed, a polarimetric configuration varying between the cameras provides a good quality identification.

The preferred position of the rectilinear polarizers provided hereabove enables to perform measurements of the light amplitude reflected by each pixel of the scene for different polarization states of the reflected light (each camera is associated with a linear polarizer, which ensures the measurement of the different polarization states). Thus, the cameras each receive, for a same pixel of the scene, a light amplitude corresponding to a different polarization of the light reflected by the pixel. Based on values measured by the cameras for different light polarization states and on the knowledge of the scene topology in the case of a 3D scene, the materials present in the scene can thus be determined (by determination of their refraction indexes).

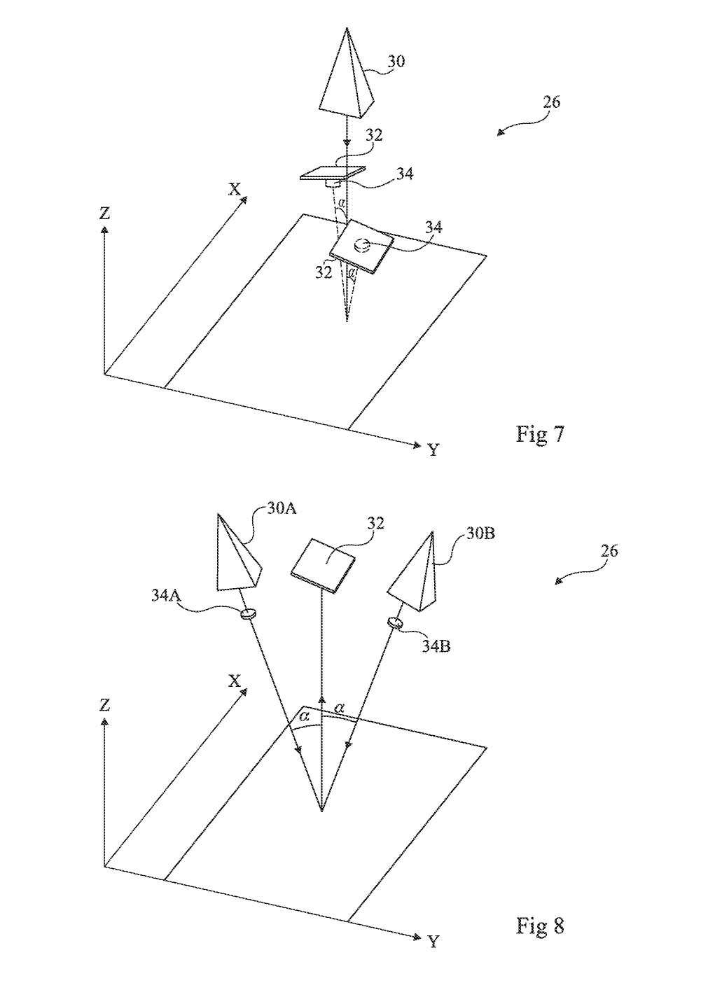

FIGS. 7 and 8 illustrate two alternative embodiments of a device according to an embodiment.

FIG. 7 shows a device similar to that of FIG. 6 in that it comprises a projector 30 of non-polarized light positioned along a direction normal to the scene, the light emitted by the projector being capable of illuminating at least a portion of the scene which is studied. In the example of FIG. 7, two cameras 32, associated with rectilinear polarizers, acquire images of the scene. The two cameras 32 are placed symmetrically with respect to the projector, the optical axis of the cameras forming an angle α with the optical axis of the projector, preferably in the range from 5 to 50°.

It will be within the abilities of those skilled in the art to select the polarizations to be imposed to the two polarizers 34, so that they detect, for a planar reference surface, the maximum and minimum values of the detected intensity.

FIG. 8 illustrates another alternative embodiment. An association of two light sources and of a camera is provided in FIG. 8, for a result similar to the embodiments of FIGS. 6 and 7.

In the example of FIG. 8, two light sources 30A, 30B are placed to illuminate, at the level of their optical axes, a same point of the scene. The optical axis of the two light sources are provided with respect to the normal to the scene to form a same angle α, preferably in the range from 5 to 50°, and are oriented symmetrically with respect to a plane normal to the scene. A single camera 32 is placed in this normal plane, and its optical axis is directed towards the central point of the light beams originating from sources 30A and 30B.

Light sources 30A, 30B are polarized. To schematize this point in FIG. 7, two polarizers 34A, 34B, fixed with respect to sources 30A, 30B and placed on the optical path of the beam originating from sources 30A, 30B. It should be noted that polarized light sources may also directly be provided.

The polarizations of the light beams of sources 30A and 30B (or the positioning of polarizers 34A and 34B in the example of FIG. 7) may be provided to limit specular reflections, which may be disturbing in the vision system. The polarizations of the light beams of sources 30A and 30B (or the positioning of polarizers 34A and 34B in the example of FIG. 7) may also be selected so that the signal reflected by a planar reference surface is received by the camera to coincide with the detected light amplitude extreme (cure of FIG. 3).

In operation, it may be provided to alternately illuminate the scene by means of projectors 30A and 30B, the camera performing a first acquisition under the illumination of projector 30A and a second acquisition under the illumination of projector 30B. In the case of a batch processing, on an assembly line, the acquisition delay between the first and second acquisition may be provided to be corrected so that the images detected during these two acquisitions are comparable.

The amplitude information detected by the camera during the two phases of activation of projectors 30A and 30B for a same area of the scene, as well as the knowledge of the topology of this area if the scene is three-dimensional, enable processing system 27 to identify the pixel material.

According to a variation of the embodiment shown in FIG. 8, polarizers 34A and 34B are not present. A rectilinear polarizer fixed with respect to camera 32 is placed in front of camera 32. The camera performs a first acquisition under the illumination of projector 30A and a second acquisition under the illumination of projector 30B. The different polarization states of the two acquisitions are then due to the fact that the scene is illuminated under a different angle by each projector 30A, 30B during the acquisitions. Thus, a single or none of the projectors may be equipped with an optical device modifying the incident polarization state.

It should be noted that different variations may be obtained based on the embodiments of FIGS. 6 to 8. Indeed, it may be provided to use numbers of light sources and of cameras different from those provided herein, as long as at least two emitting source/receiver pairs are provided in the device (at least one source for two cameras or two sources for one camera).

Of course, it should be understood that the larger the number of source/sensor pairs, the fine and more accurate the detection of the materials can be.

In practice, the number of materials to be identified in the scene may be limited. Indeed, for example, in the case of an application of the method to the identification of materials in an assembly line for printed circuits assembled on a board, it may be desired to only make the difference between conductive materials (for example, the chip interconnection copper tracks) and dielectric materials. Advantageously, such materials have very different ellipsometric signatures (light amplitude variation more significant for conductive materials than for insulating materials), which enables to distinguish between these materials. The narrowing of the selection of materials in a list enables, as seen previously, to limit the number of light source/acquisition device pairs of the identification system.

Advantageously, the structure for identifying materials in a scene provided herein may be integrated in devices for detecting the 3D topology of a scene, and particularly with the device described in US 2012/019651 patent application mentioned hereabove. To achieve this, it is sufficient to make another use of the function of certain cameras of the scene, for the identification of materials rather than for topology detection, or also to add one or a plurality of cameras dedicated to the identification of materials in the topology detection system.

According to an embodiment, the method of identifying a material in a scene comprises directly comparing to each other the acquired images corresponding to two different polarization states.

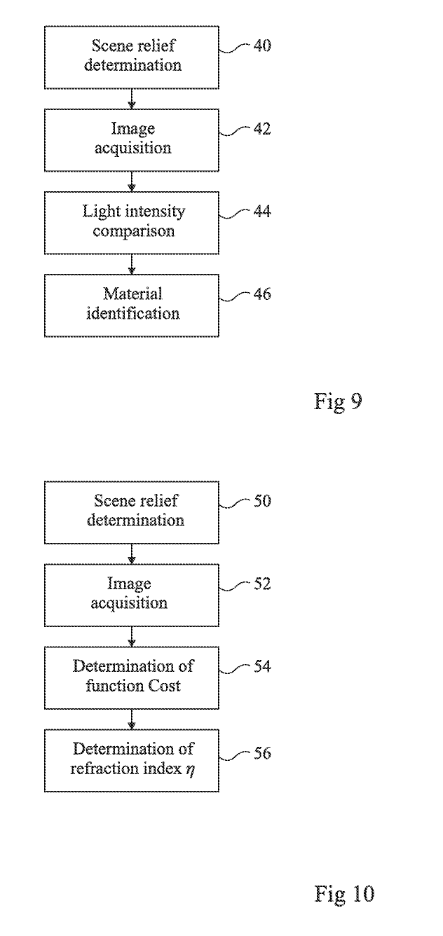

FIG. 9 shows, in the form of a block diagram, an embodiment of a method of identifying a material in a scene.

At step 40, device 28 determines the topology of the scene. This may comprise determining a three-dimensional image of the scene. A three-dimensional image corresponds to a cloud of points, for example, comprising several million points, of at least a portion of the external surface of the scene, where each point of the surface is located by its coordinates determined with respect to a three-dimensional space reference system.

At step 42, processing and calculation device 27 determines, for each point of interest of the observed scene, the light intensities measured by all the cameras of measurement device 26 observing this point of interest. Point of interest means one of the points of the scene having its position known due to the scene topology data and for which the corresponding material is desired to be identified. The positions of the image point corresponding to the point of interest in the acquired images are given by the combination of the scene topology data delivered by device 28 with, for example, information relative to the calibration of the image acquisition devices enabling to project the points originating from the topology into the acquired images.

For each point of interest of the observed scene, processing and calculation device 27 determines, in each image acquired at different polarization states by the cameras observing this point of interest of the scene, the light intensity at the image point, for example, by bilinear interpolation based on the light intensities of the pixels of an image portion around the image point.

At step 44, processing and calculation device 27 compares the light intensities determined at step 42 for a given point of interest. This comparison may for example be made in the form of a simple difference of the light intensities or of the ratio of the light intensities. Generally, the comparison state shows the variations of the light intensity according to the polarization state of the acquired images.

At step 46, processing and calculation device 27 determines the nature at the point of interest of the scene from the value of the difference determined at step 44. As an example, this may be obtained by comparing the difference with a threshold. When the difference is greater than or equal to the threshold, device 7 determines that the point of interest of the scene is made of a conductive material and, when the difference is strictly smaller than the threshold, device 7 determines that the point of interest of the scene is made of a dielectric material. The threshold used may be experimentally determined from known scenes.

When more than two images of the scene with different polarization states are acquired, step 42 comprises, based on the scene topology data delivered by device 28, determining the different light intensities for each point of interest. As an example, this determination may be performed in two steps. The first step comprises projecting the point of interest of the scene on the image plane of all the cameras to obtain the corresponding image points. The second step comprises interpolating the light intensities at each image point, for each acquired image. Step 46 may comprise a step of comparing the identifications of the nature of the materials obtained by comparing the intensity differences of a plurality of pairs of cameras with a threshold to make the identification more robust against acquisition noise.

According to an embodiment, the method of identifying a material in a scene comprises determining an extremum of a cost function obtained from the acquired images corresponding to two different polarization states.

FIG. 10 shows, in the form of a block diagram, an embodiment of a method of identifying a material in a scene.

Steps 50 and 52 are respectively identical to previously-described steps 40 and 42.

At step 54, processing and calculation device 27 determines, for each image point associated with a point of interest of the scene, a cost function Cost, for example, according to the following relation (2):

Cost=Σₖ₌₁^{N}∥I_{modeled}^{k}−I_{measured}^{k}∥ (2)

where N is the number of images acquired with different polarization states, I_{measured}^{k} is the intensity measured at the considered image point, I_{modeled}^{k} is the theoretical intensity obtained by previously-described relation (1) and ∥x∥ is a norm, for example, the absolute value. As previously described, theoretical intensity I_{modeled}^{k} particularly depends on refraction index η of the material and on vector \vec{N} normal to the surface of the observed scene. The normal vector may be determined from the topology data provided by device 28.

At step 56, processing and calculation device 27 determines refraction index η for which cost function Cost is minimum.

Cost function Cost may further comprise a curve fitting term penalizing spatial transitions between optical indexes to increase the robustness of the identification against acquisition noise. In the case where function Cost is desired to be minimized, this curve fitting term may for example be a function increasing along with the homogeneity of the optical index in the vicinity of the point of interest. The curve fitting term may for example be deduced from the learning of a plurality of scenes where the material has been identified, for example, by an observer.

Specific embodiments of the present invention have been described. Various alterations and modifications will readily occur to those skilled in the art. Further, various embodiments with various variations have been described hereabove. It should be noted that those skilled in the art may combine various elements of these various embodiments and variations without showing any inventive step.

1. A method of identifying materials in a scene, comprising the steps of:
lighting the scene;
taking at least two simultaneous measurements of the light amplitude of the scene for different states of light polarization by means of at least two measurement devices positioned along directions inclined with respect to the scene, the measurement devices comprising no variable polarization device and no light beam splitter; and
deducing an identification of the material therefrom.

2. The method of claim 1, further comprising a step of determining the topology of the scene, the material identification being further performed based on the topology of the scene.

3. The method of claim 2, wherein each measurement comprises acquiring an image and wherein the method further comprises a step of determining the light amplitudes at the points of the images acquired for different polarization states corresponding to a point of the scene based on scene topology information.

4. The method of claim 3, further comprising a step of comparing the light amplitudes at the points of the images acquired for different polarization states corresponding to a same point of the scene.

5. The method of claim 4, further comprising a step of determining the light amplitude difference at the points of the images acquired for different polarization states corresponding to a same point of the scene and a step of comparing the difference with a threshold.

6. The method of claim 3, further comprising a step of comparing, for each measurement, the light amplitude determined at the point of the acquired image corresponding to the point of the scene with a theoretical amplitude received at said point of the acquired image.

7. The method of claim 6, further comprising a step of determining the refraction index of the material for which a cost function transits through an extremum, the cost function using the determined light amplitudes and theoretical amplitudes received at the points of the images acquired for different polarization states corresponding to the point of the scene.

8. A system for identifying a material in a scene, comprising:
at least one element of a first type selected from among a light source and an image acquisition device; and
at least two elements of a second type, different from the first type, selected from among an image acquisition device and a light source, each second element being associated with a rectilinear polarizer in a fixed relationship, the system comprising no variable polarization device and no light beam splitter.

9. The system of claim 8, further comprising a device for determining the topology of the scene and a processing device capable of identifying a material in the scene based on the images acquired by the image acquisition device(s) and on the topology information delivered by the topology determination device.

10. The system of claim 8, wherein the optical axis of each element of the second type forms, with respect to the optical axis of the element of the first type, an angle in the range from 5 to 50°, the elements of the second type being distributed around the optical axis of the element of the first type.

11. The system of claim 8, wherein the image acquisition device(s) acquire images of the light amplitude of the scene for different light polarization states.

12. The system of claim 8, wherein the element of the first type is placed along an axis normal to the plane of the scene (1).

13. The system of claim 8, wherein the elements of the second type are light sources.

14. The method of claim 1, using the system of claim 13, wherein the light sources are alternately activated, the image acquisition device being provided to acquire an image for each alternation of activation of said sources.

15. An installation comprising a part conveyor and a system for identifying a material in said parts according to claim 8.
